(19) United States
(12) Patent Application Publication
(10) Pub. No.: US 2008/0143746 A1
(43) Pub. Date: Jun. 19, 2008

(54) Display of an equation with graphical data

(75) Inventor: Darren Scott Irons, Carrollton, TX (US)

Correspondence Address: TEXAS INSTRUMENTS INCORPORATED, P O BOX 655474, M/S 3999, DALLAS, TX, 75265, US

(73) Assignee: Texas Instruments Incorporated

(21) Appl. No.: 11/641,323

(22) Filed: Dec. 19, 2006

(51) Int. Cl. G09G 5/00; G06F 3/02

(52) U.S. Cl. 345/629; 345/169

(57) ABSTRACT

A graphing system that simultaneously displays an equation with the associated graph is provided. The equation is displayed on the graph. The graph may be adjusted, and the equation is automatically adjusted accordingly. Additionally, modifications to the equation may be automatically reflected on the graph. Embodiments of the present invention may be utilized in any type of electronic device capable of displaying tabular data, such as handheld calculators, computers, and the like.

### TECHNICAL FIELD

The present invention relates generally to graphing utilities and, more particularly, to displaying an equation with the corresponding graph on an electronic device.

### BACKGROUND

Electronic calculators have become a common tool for teaching students various aspects of mathematics. In particular, the features of graphing calculators are particularly advantageous in a classroom setting to teach students mathematical principals and to illustrate practical applications of concepts taught in class. In fact, many schools now recommend or require students in math classes to use graphing calculators to aid students in learning about advanced math topics, such as trigonometry and calculus.

Using a graphing calculator typically involves a user entering an equation and then entering one or more keystrokes to change the display from the equation to the associated graph. Modifying the equation is equally cumbersome, requiring the user to enter one or more keystrokes to display the equation, modify the equation, and then enter one or more keystrokes to change the display back to the associated graph.

Requiring the user to switch repeatedly back and forth between the equation and the graph makes it difficult and tedious for the user to easily see the effect of changes in the equation on the graph, and vice versa. Therefore, there is a need for a system and method to enable a user to readily see the effect of changes in an equation on a graph and the effect of changes in a graph on an equation.

### SUMMARY OF THE INVENTION

These and other problems are generally solved or circumvented, and technical advantages are generally achieved, by preferred embodiments of the present invention which provides a method and a system for displaying an equation on a graph.

In an embodiment of the present invention, a method of displaying an equation with the corresponding graph is provided. The method comprises receiving an equation, displaying a graph corresponding to the equation, and displaying the equation on the graph.

In some embodiments of the present invention, the equation may be modified either on the graph or on an equation bar, and the graph is automatically modified accordingly. Similarly, the graph may be modified, and the equation is automatically modified accordingly.

Embodiments of the present invention may be implemented in an electronic device, such as a graphing calculator or a personal computer.

It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

The following is a brief description of the drawings, which illustrate exemplary embodiments of the present invention and in which:

FIG. 1 is a block diagram of a handheld computing device in accordance with an embodiment of the present invention;

FIGS. 2a-2d illustrate an example of a handheld computing device in accordance with an embodiment of the present invention;

FIG. 3 is a block diagram of a desktop computing device in accordance with an embodiment of the present invention; and

FIG. 4 is a data flow diagram illustrating a method for simultaneously displaying a graph and an equation corresponding to the graph in accordance with an embodiment of the present invention.

### DETAILED DESCRIPTION OF ILLUSTRATIVE EMBODIMENTS

Referring now to the drawings, wherein like reference numbers are used herein to designate like or similar elements throughout the various views, illustrative embodiments of the present invention are shown and described. The figures are not necessarily drawn to scale, and in some instances the drawings have been exaggerated and/or simplified in places for illustrative purposes only. One of ordinary skill in the art will appreciate the many possible applications and variations of the present invention based on the following illustrative embodiments of the present invention.

Embodiments of the present invention are discussed below with respect to embodiments in which a graphing calculator or a personal computer are used. It should be noted, however, that embodiments of the present invention may be useful for other types of electronic devices, handheld computing devices, desktop devices, and mainframe devices. Examples of other types of handheld computing devices in which embodiments of the present invention may be useful include scientific calculators, advanced calculators able to upload and run software applications, handheld-sized limited-purpose computer devices, handheld-sized educational computer devices, handheld-sized portable computer devices, portable computer devices, personal digital assistants (PDA), palmtop computers, personal communicators, personal intelligent communicators, cellular or mobile telephones, global positioning system (GPS) devices, portable inventory logging computer devices (as may be used by courier deliverers, for example), handheld monitoring devices, handheld portable email devices, handheld portable Internet browsing devices, handheld portable gaming devices, and any combination thereof.

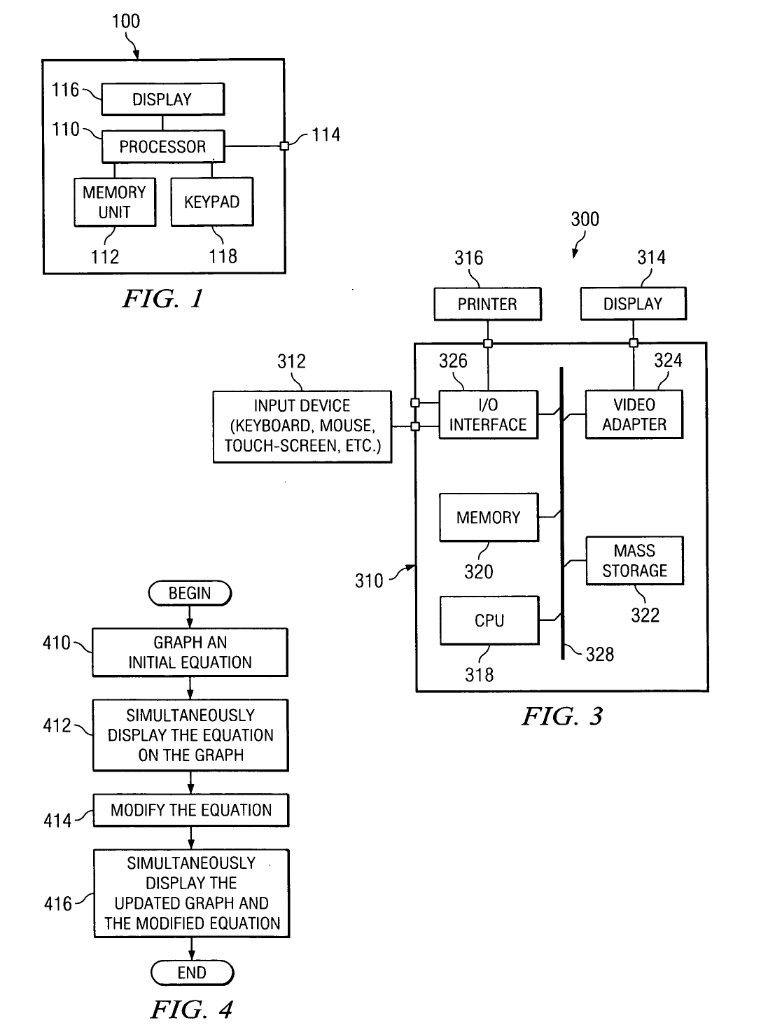

FIG. 1 is a block diagram of a handheld computing device 100 in accordance with an embodiment of the present invention. Generally, the handheld computing device 100 includes a processor 110 connected to a memory unit 112, which may include one or both of read-only memory (ROM) and random-access memory (RAM). In a preferred embodiment, however, the handheld computing device 100 includes ROM to store software programs and RAM to store intermediate data and operating results.

An optional input/output port 114 provides connectivity to other electronic devices, such as other computers, hubs, displays, or the like. In an embodiment, the input/output port 114 comprises a bi-directional connection such as a mini-A USB port. In this manner, the handheld computing device 100 may transmit information to and receive information from another electronic device. Also included in the handheld computing device 100 are a display 116 and a keypad 118.

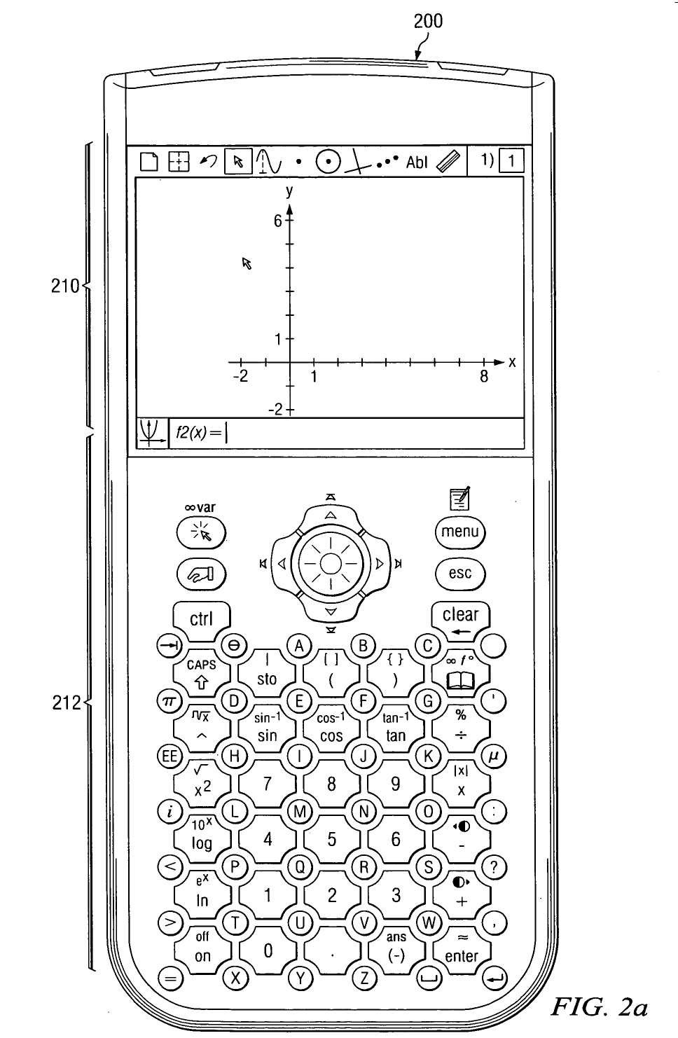

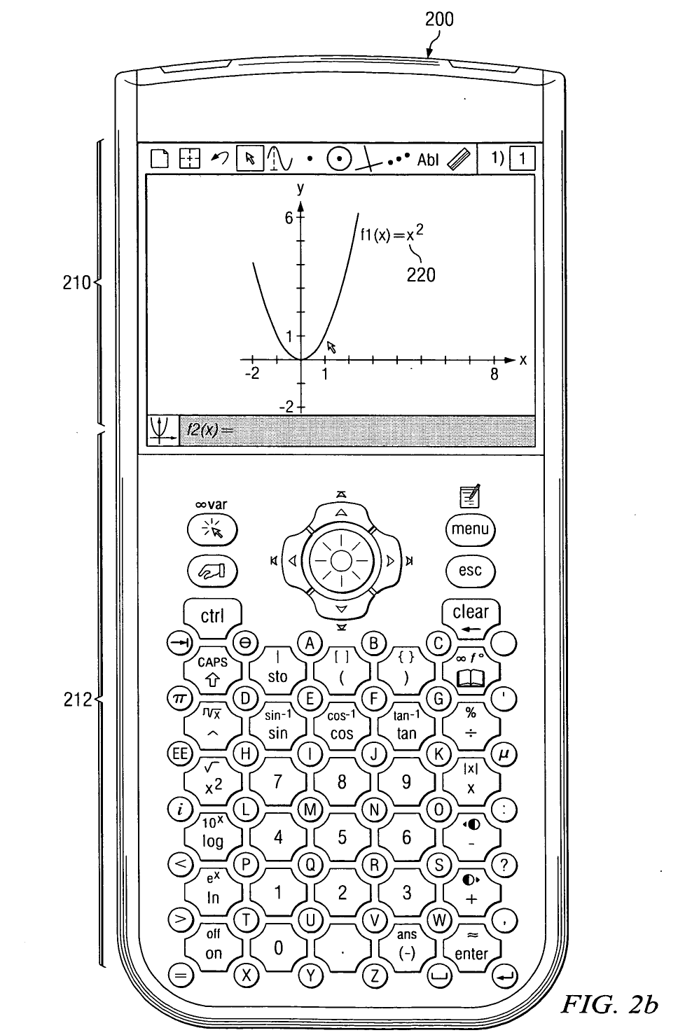

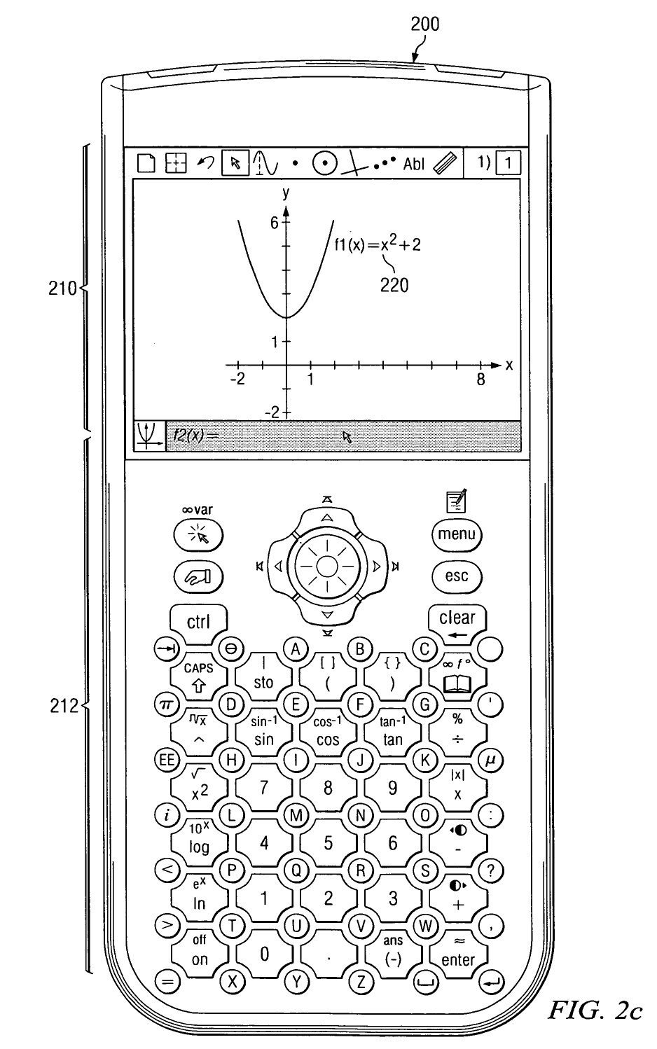

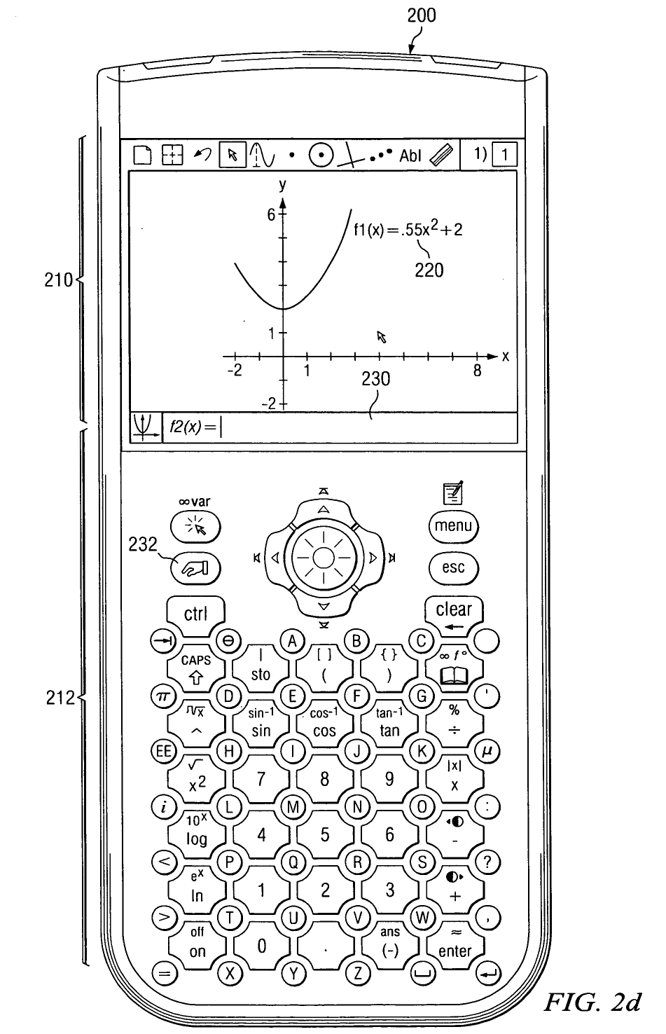

FIGS. 2a-2d illustrate an example of the handheld computing device 100 (see FIG. 1) being utilized to simultaneously display functional data and graphical data in accordance with an embodiment of the present invention. For illustrative purposes only, the handheld computing device 100 illustrated in FIGS. 2a-2d is a graphing calculator 200. It should be noted, however, that the graphing calculator 200 is used for illustrative purposes only and does not limit the invention as claimed.

As shown in FIGS. 2a-2d, the graphing calculator 200 preferably includes a graphical display 210 and a set of keys 212. Generally, the graphical display 210 provides a means upon which graphs of various functions and/or one or more lines of text/symbols may be displayed. The graphical display 210 may be, for example, an LED or LCD display. The set of keys 212 is located below the graphical display 210 and provides a method for a user, e.g., a student, to enter data and functions. Other configurations and functions may be used.

Referring now to FIG. 2a, the graphing calculator 200 is shown after being placed in a graphing mode. Generally, the graphing mode allows a user of the graphing calculator 200 to enter a function and have the resulting graph drawn on the display.

In FIG. 2b, the function f1(x)=x² has been entered and graphed in accordance with an embodiment of the present invention. In accordance with an embodiment of the present invention, the function f1(x)=x² is included on the graphical display 210, as indicated by reference numeral 220. As discussed further below, reference numeral 220 comprises an active equation. Generally, the active equation 220 is linked to the graph and provides a dynamic display of the equation that is automatically modified as changes are made to the graph. Embodiments of the present invention also provide that changes made directly to the graph are automatically reflected in the active equation 220.

FIG. 2c illustrates the ability to automatically modify the graph when the function is modified in accordance with an embodiment of the present invention. In the example illustrated in FIG. 2c, the function f1(x)=x² was modified to the function f1(x)=x²+2. As illustrated in FIG. 2c, the graph has been translated along the y-axis a positive 2 units to reflect modifications to the function.

FIG. 2d illustrates another example of a modification to the function in accordance with an embodiment of the present invention. Whereas FIG. 2c illustrated a translation, FIG. 2d illustrates a translation and a dilation. As illustrated in FIG. 2d, the function f1(x)=x²+2 was modified to the function f1(x)=0.55x²+2. Accordingly, the graph has been dilated or flattened, and translated to reflect the new equation.

The equation may be altered in any suitable method. In an embodiment, a user may position a pointer on the active equation 220 to open up a text box that allows a user to alter the function directly on the graph. Alternatively, selection of the active equation 220 may open the function on an equation line 230 along the bottom of the graphical display 210.

In yet another embodiment, the active equation 220 may be altered by directly modifying the graph. For example, a user may depress a grab key 232 that allows a user to “grab” portions of the graph line and drag it as desired. For example, a user may depress the grab key 232, grab an end of the graph line and drag the end of the graph to dilate the function. As another example, a user may depress the grab key 232, grab the graph line and translate the graph along the x-axis and/or the y-axis.

As one of ordinary skill in the art will appreciate, displaying the function simultaneously on the graph allows a user to easily see the interaction of specific portions of the function and the resulting graph.

FIG. 3 is a block diagram of a desktop computing system 300 that may also be used in accordance with an embodiment of the present invention. Generally, the methods discussed above with reference to FIGS. 2a-2d and a handheld computing device may also be implemented on other electronic devices, such as the desktop computing system 300 illustrated in FIG. 3. It should be noted, however, that the desktop computing system 300 discussed herein is provided for illustrative purposes only and that other electronic devices may be used.

The desktop computing system 300 may comprise, for example, a desktop computer, a workstation, a laptop computer, a personal digital assistant, a dedicated unit customized for a particular application, or the like. Accordingly, the components of the desktop computing system 300 disclosed herein are for illustrative purposes only and other embodiments of the present invention may include additional or fewer components.

In an embodiment, the desktop computing system 300 comprises a processing unit 310 equipped with one or more input devices 312 (e.g., a mouse, a keyboard, or the like), and one or more output devices, such as a display 314, a printer 316, or the like. Preferably, the processing unit 310 includes a central processing unit (CPU) 318, memory 320, a mass storage device 322, a video adapter 324, and an I/O interface 326 connected to a bus 328. The bus 328 may be one or more of any type of several bus architectures including a memory bus or memory controller, a peripheral bus, video bus, or the like. The CPU 318 may comprise any type of electronic data processor. For example, the CPU 318 may comprise a Pentium™ processor from Intel Corp., an Athlon processor from Advanced Micro Devices, Inc., a Reduced Instruction Set Computer (RISC), an Application-Specific Integrated Circuit (ASIC), or the like. The memory 320 may comprise any type of system memory such as static random access memory (SRAM), dynamic random access memory (DRAM), synchronous DRAM (SDRAM), read-only memory (ROM), a combination thereof, or the like. In an embodiment, the memory 320 may include ROM for use at boot-up, and DRAM for data storage for use while executing programs.

The mass storage device 322 may comprise any type of storage device configured to store data, programs, and other information and to make the data, programs, and other information accessible via the bus 328. In a preferred embodiment, the mass storage device 322 is configured to store the emulation program to be executed by the CPU 318. The mass storage device 322 may comprise, for example, one or more of a hard disk drive, a magnetic disk drive, an optical disk drive, or the like.

The video adapter 324 and the I/O interface 326 provide interfaces to couple external input and output devices to the processing unit 310. As illustrated in FIG. 3, examples of input and output devices include the display 314 coupled to the video adapter 324 and the mouse/keyboard 312 and the printer 316 coupled to the I/O interface 326. Other devices may be coupled to the processing unit 310.

It should be noted that the handheld computing device 100 and the desktop computing system 300 may include other components. For example, the handheld computing device 100 and the desktop computing system 300 may include power supplies, cables, a motherboard, removable storage media, cases, a network interface, and the like. These other components, although not shown, are considered part of the handheld computing device 100 and the desktop computing system 300.

FIG. 4 is a data flow diagram illustrating a method for simultaneously displaying a graph and an equation corresponding to the graph in accordance with an embodiment of the present invention. The process begins in step 410, wherein an initial equation is entered by a user. In step 412, the equation is graphed with the corresponding equation displayed on the screen. As one of ordinary skill in the art will appreciate, displaying the equation on the graph aids in the user's understanding of the equation.

After step 412, the process proceeds to step 414, wherein a user may optionally modify the equation, and step 416, wherein the modified equation is displayed with the modified graph.

It should be noted that all functions described herein may be performed in either hardware or software, or some combination thereof. In a preferred embodiment, however, the functions are performed by a processor such as a computer or an electronic data processor in accordance with code such as computer program code, software, and/or integrated circuits that are coded to perform such functions, unless indicated otherwise. In other embodiments, a hardware system may be specifically designed to perform one or more of the functions described herein.

Although embodiments of the present invention and at least some of its advantages have been described in detail, it should be understood that various changes, substitutions, and alterations can be made herein without departing from the spirit and scope of the invention as defined by the appended claims. Moreover, the scope of the present application is not intended to be limited to the particular embodiments of the process, machine, manufacture, composition of matter, means, methods, and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for an electronic device to display data, the method comprising:
receiving a mathematical function;
displaying a graph corresponding to the mathematical function on a screen;
displaying the mathematical function on the graph; and
linking the graph to the mathematical function such that modifications made to the mathematical function dynamically modify the graph.

2. The method of claim 1, further comprising receiving modifications to the graph via actuation of one or more keys creating a modified graph, the modifications including at least one of a shape and a position of the graph.

3. The method of claim 1, further comprising modifying the mathematical function to reflect changes made directly to the graph.

4. The method of claim 1, wherein modifications to the mathematical function are received from modifications to the mathematical function displayed on the graph.

5. The method of claim 1, wherein modifications to the mathematical function are received from modifications to the mathematical function displayed on an equation bar.

6. A calculator comprising:
a screen capable of displaying a graph and text;
a keypad having a plurality of keys; and
a processor communicatively coupled to the screen and the keypad, the processor being configured to:
receive an equation;
display a graph corresponding to the equation on the screen;
display the equation on the graph;
dynamically modify the graph when one or more modifications to the equation are received; and
dynamically modifying the equation when one or more modifications to the graph are received.

7. The calculator of claim 6, wherein the processor is further configured to receive the one or more modifications to the graph via actuation of one or more keys of the keypad, the one or more modifications to the graph including at least one of a shape and a position of the graph.

8. The calculator of claim 6, wherein the processor is further configured to receive the one or more modifications to the equation via actuation of one or more keys of the keypad.

9. The calculator of claim 6, wherein the processor is further configured to receive the one or more modifications to the equation from modifications directly to the equation displayed on the graph.

10. The calculator of claim 6, wherein processor is further configured to receive the one or more modifications to the equation from modifications made to the equation displayed on an equation bar.

11. A computer program product for displaying an equation and a graph corresponding to the equation, the computer program product having a medium with a computer program embodied thereon, the computer program comprising:
computer program code for receiving the equation; and
computer program code for generating display data to display on a screen, the display data comprising graph data to display the graph corresponding to the equation and an active equation.

12. The computer program product of claim 11, further comprising computer program code for modifying at least one of a shape and a position of the graph in accordance with one or more received instructions.

13. The computer program product of claim 12, further comprising computer program code for automatically modifying the active equation to correspond to the graph after the modifying at least one of the shape and the position of the graph.

14. The computer program product of claim 11, further comprising computer program code for receiving one or more modifications to the active equation.

15. The computer program product of claim 14, further comprising computer program code for modifying the graph according to the one or more modifications to the active equation.

16. The computer program product of claim 14, wherein the modifications to the active equation are received from modifications to the active equation displayed on the graph.

17. The computer program product of claim 14, wherein the modifications to the active equation are received from modifications to the active equation displayed on an equation bar.
